(19) United States
(12) Patent Application Publication
(10) Pub. No.: US 2026/0239092 A1
(43) Pub. Date: Aug. 13, 2026

(54) SESSION CONTROL APPARATUS AND DATA PROCESSING APPARATUS, AND SERVICE METHOD BETWEEN DIFFERENT PLMNS, PERFORMED BY SAME APPARATUSES

(71) Applicant: SK TELECOM CO., LTD., Seoul (KR)

(72) Inventors: Hyeon Mo GU, Seoul (KR); Kyu Seong PARK, Seoul (KR); Joong Gunn PARK, Seoul (KR); Dong Jin LEE, Seoul (KR)

(21) Appl. No.: 19/472,291

(22) PCT Filed: Jul. 13, 2023
(86) PCT No.: PCT/KR2023/010028

§ 371 Date: Oct. 3, 2025

(30) Foreign Application Priority Data
Apr. 17, 2023 (KR) 10-2023-0050211

(51) Int. Cl. H04W 28/02; H04L 61/4511; H04W 8/08

(52) U.S. Cl. CPC H04W 28/0247; H04L 61/4511; H04W 8/082

(57) ABSTRACT

The present invention proposes a new technology plan for improving the quality felt by a customer and reducing international line traffic by implementing a specific technical configuration for local break-out on site so that a domestic subscriber terminal in overseas accesses an application server nearby (e.g., in an overseas area).

### TECHNICAL FIELD

The present disclosure relates to a technology (referred to as roaming) enabling a UE of a different mobile network operator to also use a mobile communication service through interworking between different public land mobile networks (PLMNs).

This application is based on and claims priority to Korean Patent Application No. 10-2023-0050211, filed on Apr. 17, 2023, in the Korean Intellectual Property Office, the disclosure of which is herein incorporated by reference in its entirety.

### BACKGROUND ART

5G defines a network structure for supporting a UE, a base station (access), a core, and a server end to end. 5G defines a network structure in which an area (control plane) of a control signaling function and an area (user plane) of a data transmission/reception function are divided by separating control signaling and data transmission/reception functions performed complexly by a single node (e.g., a S-GW and a P-GW) in existing LTE (4G).

In 5G, a control plane (CP) node may be defined as an access and mobility management function (AMF) that controls wireless section access of a UE, a policy control function (PCF) that manages/controls UE information, subscription service information by each UE, and a policy on charging or the like, a session management function (SMF) that controls/manages a session for each UE to use a data service, a network exposure function (NEF) that is responsible for a function of sharing information with an external network, a unified data management/authentication function (UDM/AUSF) that manages/controls a subscriber DB and authentication of a user, a function network repository (NRF) that manages/controls information about each network function (NF) in a network, a charging function (CHF) that processes charging of a subscriber, and the like.

Further, in 5G, a user plane (UP) node may be defined as a user plane function that performs data transmission and reception between a UE and a server on an external service network (e.g., the Internet) through a session with the UE, based on control (interworking) of the SMF.

In 5G, a control node of a control plane and a data node of a user plane may be collectively referred to as a network function (NF).

Roaming is a technology that enables a service between different mobile network operators, that is, different public land mobile networks (PLMNs), and is a service allowing a home subscriber UE subscribing to a home PLMN to use a mobile communication service in a visited PLMN by using the same phone number.

A roaming service generally employs a home-routed roaming method in which a home PLMN (hereinafter, an HPLMN) establishes an agreement with a visited PLMN (hereinafter, a VPLMN) to provide a service through interworking between core devices.

The home-routed roaming method is briefly described as follows.

When a home subscriber UE travels abroad, the UE accesses an overseas base station, that is, an RAN of a VPLMN, to use an AMF, an SMF, and a UPF of the VPLMN.

Here, VPLMN devices may provide a roaming service to the UE by interworking with an AUSF of an HPLMN, an SMF of the HPLMN, and a UPF of the HPLMN. In this process, HPLMN devices may serve to authenticate the UE accessing the VPLMN, deliver required QoS policies, and collect usage data for billing.

In the current home-routed roaming method, the HPLMN devices are physically located domestically, while the VPLMN is physically located overseas.

Therefore, even though the home subscriber UE accesses the overseas base station, that is, the RAN of the VPLMN, all traffic used by the UE through roaming is transmitted domestically.

That is, in the current roaming service, even though an application server to be accessed/used by the domestic subscriber UE located overseas is located in an overseas region close to the UE, the domestic subscriber UE accesses a domestic application server, and thus the quality of experience of a customer including a response speed may be reduced.

### DISCLOSURE OF INVENTION

### Technical Problem

Accordingly, the present disclosure is to realize a novel technical method that enables a domestic subscriber UE located overseas to access an application server located nearby (e.g., in an overseas region) by local breakout to improve quality of experience of a customer and reduce international circuit traffic.

### Solution to Problem

A session control device according to an embodiment of the present disclosure includes: a controller configured to enable traffic according to a service between a home public land mobile network (hereinafter, an HPLMN) and a visited PLMN (hereinafter, a VPLMN) to be processed in a user plane function (UPF) of an HPLMN deployed in a region where a UE using the service is located, based on whether the UE is a UE of a different operator UE; and a state management unit configured to manage a network state per different operator for the UPF of the HPLMN.

Specifically, whether the UE is the UE of the different operator may be identified according to at least one of the VPLMN, requested single-network slice selection assistance information (S-NSSAI), an international mobile equipment identity (IMEI), and an international mobile subscriber identity (IMSI) of the UE.

Specifically, the controller may be configured to select a UPF of an HPLMN to process the traffic by using external operator information about the UE, and to transmit the external operator information.

Specifically, the state management unit may be configured to manage a network state per external operator information for the selected UPF of the HPLMN, based on a state (e.g., out-of-service, RTT, throughput quality of service (QoS), error rate, and packet fragmentation) of data traffic in a section between a UPF of a VPLMN and a UPF of an HPLMN reported using information in which the external operator information and a downlink GTP-U TEID from the selected UPF of the HPLMN are mapped.

Specifically, the state management unit is configured to transmit the external operator information when transmitting a session establishment request and/or a session modification request for the UE to the selected UPF of the HPLMN to enable the UPF of the HPLMN to retain the information in which the transmitted external operator information and the downlink GTP-U TEID for the UE are mapped and to use the information when reporting a state of the UPF or data traffic.

Specifically, the state management unit is configured to: manage a network state of external operator information according to a report for a UPF of a specific HPLMN when a state of the UPF or data traffic including the external operator information and GTP-U information is reported from the UPF of the specific HPLMN; and exclude the UPF of the specific HPLMN from selection according to the network state of the external operator information about the specific HPLMN when the controller selects the UPF of the HPLMN by using the external operator information.

Specifically, the controller is configured to: select a UPF of an HPLMN to process the traffic by using external operator information about the UE; and enable the UE to access a service server located close to the UE through a domain name server (DNS) close to the selected UPF of the HPLMN.

Specifically, the controller may be configured to: select a DNS address according to the UPF of the HPLMN with a local configuration in which a DNS address is preset for each UPF or UPF group to transmit the DNS address to the UE; or obtain a DNS address selected by the selected UPF of the HPLMN to transmit the DNS address to the UE.

Specifically, the controller may be configured to adjust a maximum transmission unit (MTU) size for the UE according to presence and/or type of a security protocol header in a section between the UPF of the VPLMN and the UPF of the HPLMN to process the traffic.

Specifically, the controller may be configured to: select an MTU value according to the UPF of the HPLMN with a local configuration in which an IPv4 link MTU is preset for each UPF or UPF group to transmit the MTU value to the UE; or obtain an MTU value selected by the selected UPF of the HPLMN to transmit the MTU value to the UE.

Specifically, the state management unit may be configured to manage latency and throughput information about a UE-UPF-Internet section and latency and throughput information between the session control device and a UPF of an HPLMN in a different region inclusively when managing the network state per different operator for the UPF of the HPLMN.

Specifically, the controller may be configured to: delete a PDU session of the UE using the service by using GTP-U information according to the report when detection of a failure is reported as the state of the UPF or the data traffic; and select a UPF of a predetermined backup HPLMN when the PDU session of the UE is reattached.

Specifically, the controller may be configured to transmit a request to be transmitted to the selected UPF of the HPLMN for the UE by including at least one of a DNS address request and an MTU request when there is at least one of the DNS address request and the MTU request in a session-related message from the UE.

A data processing device according to an embodiment of the present disclosure includes: an information identification unit configured to identify external operator information also transmitted when receiving a request for a UE using a service between a home public land mobile network (hereinafter, an HPLMN) and a visited PLMN (hereinafter, a VPLMN); and a controller configured to manage information in which the identified external operator information and a downlink GTP-U TEID for the UE are mapped and to use the information when reporting a state of data traffic in a section between a UPF of a VPLMN and a UPF of an HPLMN to process traffic according to the service.

Specifically, the controller is configured to identify and transmit related external operator information and GTP-U information from the mapping information when reporting the state of the data traffic to an SMF of the HPLMN to enable the SMF of the HPLMN to manage a network state per external operator information for the UPF of the HPLMN by using at least one of the external operator information and GTP-U information according to the report.

Specifically, when at least one of a DNS address request and an MTU request is transmitted when receiving the request for the UE, the controller may be configured to select a DNS address and an MTU related to the data processing device with a local configuration in which at least one of a DNS address and an MTU is preset for each system, each DNN, or each external operator information and to transmit the DNS address and the MTU via a response to the request for the UE.

A method for a service between different PLMNs performed by a session control device according to an embodiment of the present disclosure includes: a control operation of enabling traffic according to a service between a home public land mobile network (hereinafter, an HPLMN) and a visited PLMN (hereinafter, a VPLMN) to be processed in a user plane function (UPF) of an HPLMN deployed in a region where a UE using the service is located, based on whether the UE is a UE of a different operator UE; and a state management operation of managing a network state per different operator for the UPF of the HPLMN.

A method for a service between different PLMNs performed by a data processing device according to an embodiment of disclosure the present includes: an information identification operation of identifying external operator information also transmitted when receiving a request for a UE using a service between a home public land mobile network (hereinafter, an HPLMN) and a visited PLMN (hereinafter, a VPLMN); and a control operation of managing information in which the identified external operator information and a downlink GTP-U TEID for the UE are mapped and using the information when reporting a state of data traffic in a section between a UPF of a VPLMN and a UPF of an HPLMN to process traffic according to the service.

### Advantageous Effects of Invention

According to embodiments of the present disclosure, based on deployment of an H-UPF of an HPLMN in a region of another PLMN (e.g., an overseas region), a specific technical configuration of enabling local breakout is realized so that a domestic subscriber UE accesses an application server located nearby (e.g., in an overseas region).

Accordingly, the present disclosure realizes a novel technical method that enables a domestic subscriber UE located overseas to access an application server located nearby (e.g., in an overseas region) by local breakout, thereby improving quality of experience of a customer and reducing international circuit traffic.

### BRIEF DESCRIPTION OF DRAWINGS

FIG. 1 is a schematic diagram illustrating an existing roaming service.

FIG. 2 and FIG. 3 are schematic diagrams illustrating a method for a service (e.g., a roaming service) between different PLMNs proposed in the present disclosure.

FIG. 4 is a block diagram illustrating the configuration of a session control device and a data processing device according to an embodiment of the disclosure.

FIG. 5 and FIG. 6 illustrate a scenario of diverting a call to a UPF of a backup HPLMN when a failure occurs in a section between a UPF of a VPLMN and a UPF of an HPLMN according to the present disclosure.

FIG. 7 illustrates an embodiment of a call flow for selecting a DNS and an MTU by the method for the service between the different PLMNs proposed in the present disclosure.

FIG. 8 illustrates a call flow for managing mapping information used by a UPF when reporting failure detection and/or failure recovery by the method for the service between different PLMNS proposed in the present disclosure.

FIG. 9 illustrates a call flow for processing when detecting a failure in a section between a UPF of a VPLMN and a UPF of an HPLMN and recovering from the failure by the method for the service between the different PLMNs proposed in the present disclosure.

### BEST MODE FOR CARRYING OUT THE INVENTION

Hereinafter, various embodiments of the disclosure will be described with reference to the accompanying drawings.

The present disclosure relates to a technology (referred to as roaming) enabling a UE of a different mobile network operator to also use a mobile communication service through interworking between different mobile network operators, that is, different public land mobile networks (PLMNs).

5G defines a network structure for supporting a UE, a base station (access), a core, and a server end to end. 5G defines a network structure in which an area (control plane) of a control signaling function and an area (user plane) of a data transmission/reception function are divided by separating control signaling and data transmission/reception functions performed complexly by a single node (e.g., a S-GW and a P-GW) in existing LTE (4G).

In 5G, a control plane (CP) node may be defined as an access and mobility management function (AMF) that controls wireless section access of a UE, a policy control function (PCF) that manages/controls UE information, subscription service information by each UE, and a policy on charging or the like, a session management function (SMF) that controls/manages a session for each UE to use a data service, a network exposure function (NEF) that is responsible for a function of sharing information with an external network, a unified data management/authentication function (UDM/AUSF) that manages/controls a subscriber DB and authentication of a user, a network repository function (NRF) that manages/controls information about each network function (NF) in a network, a charging function (CHF) that processes charging of a subscriber, and the like.

Further, in 5G, a user plane (UP) node may be defined as a user plane function that transmits and receives data between a UE and a server on an external service network (e.g., the Internet) through a session with the UE, based on control (interworking) of the SMF.

In 5G, a control node of a control plane and a data node of a user plane may be collectively referred to as a network function (NF).

Roaming is a technology that enables a service between different mobile network operators, that is, different public land mobile networks (PLMNs), and is a service allowing a home subscriber UE subscribing to a home PLMN to use a mobile communication service in a visited PLMN by using the same phone number.

A roaming service generally employs a home-routed roaming method in which a home PLMN (hereinafter, an HPLMN) establishes an agreement with a visited PLMN (hereinafter, a VPLMN) to provide a service through interworking between core devices.

The home-routed roaming method is briefly described as follows.

When a home subscriber UE travels abroad, the UE accesses an overseas base station, that is, an RAN of a VPLMN, to use an AMF, an SMF, and a UPF of the VPLMN.

Here, VPLMN devices may provide a roaming service to the UE by interworking with an AUSF of an HPLMN, an SMF of the HPLMN, and a UPF of the HPLMN. In this process, HPLMN devices may serve to authenticate the UE accessing the VPLMN, deliver required QoS policies, and collect billing usage.

In the current home-routed roaming method, the HPLMN devices are physically located domestically, while the VPLMN is physically located overseas.

Therefore, even though the home subscriber UE accesses the overseas base station, that is, the RAN of the VPLMN, all traffic used by the UE through roaming is transmitted domestically.

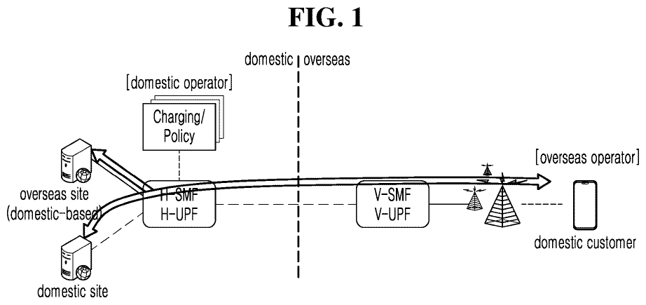

FIG. 1 illustrates an existing roaming service in which all traffic from a domestic subscriber UE located overseas is transmitted domestically.

As illustrated in FIG. 1, the domestic subscriber UE (domestic customer) located overseas accesses an overseas base station, that is, an RAN of a VPLMN, and uses an SMF of the VPLMN (hereinafter, a V-SMF) and a UPF of the VPLMN (hereinafter, a V-UPF).

The V-SMF may request service interworking for the UE (domestic customer) from an SMF of an HPLMN (hereinafter, an H-SMF) to which the UE (domestic customer) subscribes (e.g., a DNS address request), and may perform an overall procedure of controlling and generating a session for the UE (domestic customer) according to a response thereto.

Accordingly, the UE (domestic customer) may use a mobile communication service (particularly data communication) through the session (V-UPF to H-UPF) generated through interworking/control between the V-SMF and the H-SMF.

However, according to the existing roaming service, the H-SMF provides a domestic DNS address during a process of interworking with the V-SMF for session control/generation, and thus the domestic subscriber UE (domestic customer) located overseas accesses an application server located domestically (e.g., a domestically based overseas site) through a domestic DNS even though an application server that the domestic subscriber UE wants to access/use is located overseas.

According to the existing roaming service, all traffic of the domestic subscriber UE (domestic customer) located overseas is transmitted domestically, which reduces quality of experience (QoE) of the customer, such as a response speed, and increases international circuit traffic.

Accordingly, the present disclosure proposes a novel technical method that enables a domestic subscriber UE located overseas to access an application server located nearby (e.g., in an overseas location) by local breakout to improve quality of experience (QoE) of a customer and reduce international circuit traffic.

A key configuration of the technical method proposed in the present disclosure is briefly described below.

The present disclosure is based on deployment of a UPF of an HPLMN (hereinafter, an H-UPF) in a region (e.g., an overseas location) physically close to a domestic subscriber UE (domestic customer) using a roaming service.

In the present disclosure, as a method for deploying the H-UPF in the region (e.g., the overseas location) physically close to the UE (domestic customer), \textcircled{1} a deployment method using a multi-cloud/data center (e.g., a public cloud) or \textcircled{2} a deployment method in which an operator directly establishes a server in a corresponding region is possible.

That is, the present disclosure may deploy a 5G SA/NSA UPF (H-UPF) device in an overseas location using the foregoing methods \textcircled{1} and \textcircled{2}, and may provide an edge service utilizing a 5G GW control/user plane separation technology.

Accordingly, the present disclosure enables local breakout so that a UE (domestic customer) may access an application server located nearby (e.g., in an overseas location), based on the foregoing basic H-UPF deployment.

Specifically, the present disclosure may deploy a DNS physically close to the H-UPF and instructs the UE (domestic customer) to use the DNS, thereby allowing the UE (domestic customer) to access the application server located nearby (e.g., in the overseas location).

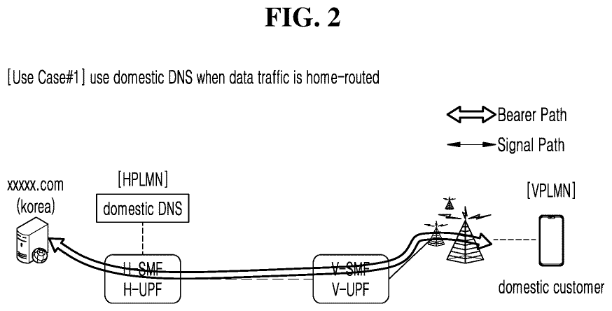

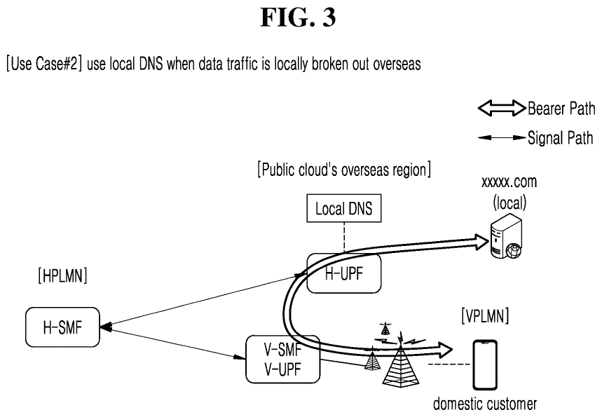

FIG. 2 and FIG. 3 conceptually and briefly illustrate a method for a service (e.g., a roaming service) between different PLMNs proposed in the present disclosure.

A domestic subscriber UE (domestic customer) located overseas accesses an overseas base station, that is, an RAN of a VPLMN, and uses a V-SMF and a V-UPF.

The V-SMF may request service interworking for the UE (domestic customer) from an H-SMF to which the UE (domestic customer) subscribes (e.g., a DNS address request), and may perform an overall procedure of controlling and generating a session for the UE (domestic customer) according to a response thereto.

Accordingly, the UE (domestic customer) may use a mobile communication service (particularly data communication) through the session (V-UPF to H-UPF) generated through interworking/control between the V-SMF and the H-SMF.

Here, in the present disclosure, the H-SMF provides an address of a DNS physically close to the H-UPF involved in the session of the UE (domestic customer) during a process of interworking with the V-SMF for session control/generation.

As illustrated in FIG. 2, when a domestic DNS address is provided, the UE (domestic customer) may use a roaming service in which data traffic is home-routed according to use case #1.

However, as illustrated in FIG. 3, when an overseas local DNS address is provided, the UE (domestic customer) may use a roaming service in which data traffic is locally broken out according to use case #2.

Local breakout of traffic used by the UE (domestic customer) through roaming makes it possible to improve round-trip time (RTT) from the UE (domestic customer) to an application server by up to 99% and to increase a webpage access speed by 50% in an outbound roaming scenario (when a domestic subscriber uses a roaming service overseas).

Furthermore, the present disclosure employs an internet service provider (ISP) for interworking between the H-UPF and V-UPF, and a connection therebetween may use a VPN for security.

In the present disclosure, since using the VPN between the H-UPF and V-UPF requires an additional security protocol header (e.g., IPsec), the UE is allowed to adjust a maximum transmission unit (MTU) size to prevent unnecessary fragmentation.

According to the key configuration of the present disclosure, a DNS address according to the H-UPF of the UE (domestic customer) may be transmitted to the UE (domestic customer), and thus the UE (domestic customer) may access a DNS and an application server located nearby, thereby improving quality of experience (QoE), such as a response speed.

Furthermore, according to the key configuration of the present disclosure, an MTU value (e.g., an IPv4 link MTU value) according to the H-UPF of the UE (domestic customer) may be transmitted to the UE (domestic customer), and thus the UE (domestic customer) may configure an appropriate MTU size based on the presence/type of a security protocol header between the V-UPF and the H-UPF, which prevents unnecessary fragmentation in a network section, thereby improving performance.

Furthermore, in the present disclosure, since a data traffic state (e.g., out-of-service, RTT, throughput QoS, error rate, and packet fragmentation) may change between the H-UPF and the V-UPF according to a VPLMN, the data traffic state is detected for each VPLMN, and when a failure occurs in a VPLMN within the same overseas region, only the VPLMN is isolated, thereby preventing services in other VPLMNs from not being affected.

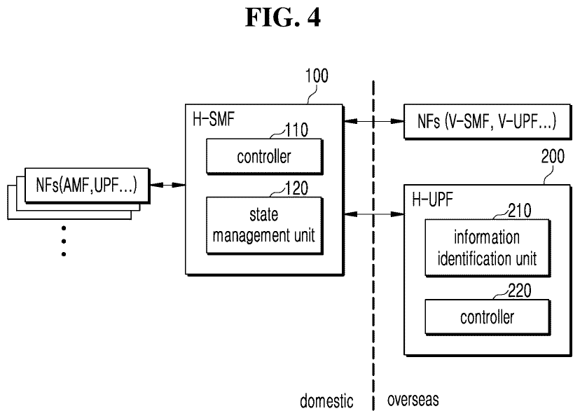

Hereinafter, a technical method (hereinafter, the method for the service between the different PLMNs) proposed in the present disclosure will be described with reference to FIG. 4.

Specifically, the present disclosure proposes a session control device and a data processing device as NFs that implement a proposed technology, that is, the method for the service (e.g., the roaming service) between the different PLMNs.

FIG. 4 illustrates the respective configurations of a session control device and a data processing device.

First, the configuration of the session control device 100 according to an embodiment of the present disclosure will be described with reference to FIG. 4.

The session control device 100 of the present disclosure may be a CU-CP, an SMF, or an SGW-C/PGW-C, and may be a device belonging to an operator's home PLMN from the perspective of a roaming service for a customer (e.g., a domestic customer) accessing other PLMNS (e.g., overseas).

However, for convenience of explanation, the session control device 100 will be described below as the SMF (hereinafter, an H-SMF), which is one of the CU-CP, the SMF, and the SGW-C/PGW-C.

As illustrated in FIG. 4, the session control device 100 of the present disclosure includes a controller 110 and a state management unit 120.

The entirety or at least a portion of the foregoing configuration of the session control device 100 may be configured as a hardware module, a software module, or a combination of hardware and software modules.

Here, the software module may be understood as, for example, an instruction executed by a processor that controls an operation within the session control device 100, and the instruction may be stored in a memory within the session control device 100.

Ultimately, the session control device 100 of the present disclosure implements the method for the service (e.g., the roaming service) between the different PLMNs proposed in the present disclosure through the foregoing configuration. Hereinafter, each component in the session control device 100 for implementing the method will be described in more detail.

The controller 110 is responsible for a function of n H-UPF) enabling a UPF of the HPLMN (hereinafter, an deployed in a region where a UE using a service between the HPLMN and a VPLMN is located to process traffic according to the service, based on whether the UE is a UE of another operator.

Whether the UE is the UE of the other operator may be identified based on at least one of a VPLMN, requested single-network slice selection assistance information (S-NSSAI), an international mobile equipment identity (IMEI), and an international mobile subscriber identity (IMSI) of the UE.

As described above, the present disclosure is based on the deployment of a 5G SA/NSA UPF (H-UPF) device in an overseas location.

Accordingly, when the UE using the service (i.e., a roaming service) between the HPLMN and the VPLMN is not the UE of the other operator (e.g., a domestic customer), the controller 110 may enable the H-UPF deployed in the region where the UE (e.g., the domestic customer) is located to process traffic according to the current roaming service by using external operator information accessed by the UE (e.g., the domestic customer).

The external operator information may be one or a combination of a plurality of pieces of the following information.
Serving PLMN information for UE
Required RTT (latency) and throughput for roaming UE
Required local/remote DNS information for roaming UE
Geographical location (physical and logical) for NFs

In a specific embodiment, when the UE of the domestic customer attempts to use the roaming service overseas, a PDU session establishment request from the UE (e.g., the domestic customer) connected through the overseas VPLMN is received by the session control device (H-SMF) 100 of the present disclosure via an AMF (not shown)/V-SMF (e.g., Nsmf_PDU_Create Request).

When the PDU session establishment request from the UE (e.g., the domestic customer) is received via the AMF (not shown)/V-SMF as described above, the controller 110 selects an H-UPF to process roaming traffic of the UE (e.g., the domestic customer) by using the external operator information about the UE (e.g., the domestic customer).

For example, the controller 110 may select the operator's H-UPF (e.g., 200) deployed closest to the location of the UE (e.g., the domestic customer) by using the external operator information about the current UE (e.g., the domestic customer), based on information (referred to as H-SMF configuration information) that designates a nearby H-UPF for each external operator information, using external operator information as a selection factor.

Further, the controller 110 may select the operator's H-UPF (e.g., 200) for the UE (e.g., the domestic customer) according to the reported state of data traffic (e.g., out-of-service, RTT, throughput QoS, error rate, or packet fragmentation) of each H-UPF to be described below by using the external operator information about the current UE (e.g., the domestic customer).

The controller 110 selects/transmits an address of a DNS close to the currently selected H-UPF (e.g., 200) to the UE (e.g., the domestic customer), thereby enabling the UE (e.g., the domestic customer) to access a service server (i.e., an application server) located nearby through the DNS close to the currently selected H-UPF (e.g., 200).

Specifically, in a first embodiment, the controller 110 of the session control device (H-SMF) 100 has a local configuration in which a DNS address is preset for each UPF or UPF group, and may select a DNS address according to the currently selected H-UPF (e.g., 200) with the local configuration.

The controller 110 may include the selected DNS address in a response message (e.g., Nsmf_PDU_Create Response) sent to the V-SMF after a PFCP establishment request/response with the selected H-UPF (e.g., 200) for the UE (e.g., the domestic customer), thereby transmitting the selected DNS address to the UE (e.g., the domestic customer).

In a second embodiment, the controller 110 may obtain the DNS address selected by the currently selected H-UPF (e.g., 200), and may transmit the DNS address to the UE (e.g., the domestic customer).

Describing the second embodiment in detail, when a PDU session establishment request from the UE (e.g., the domestic customer) is received via the AMF (not shown)/V-SMF as described above, if a PCO (ePCO) IE exists in the received message (e.g., Nsmf_PDU_Create Request) and a DNS address request exists in the PCO (ePCO), the controller 110 may include the DNS address request in the PFCP establishment request to be transmitted to the H-UPF (e.g., 200).

The H-UPF (e.g., 200) of the present disclosure may have/manage a local configuration in which a DNS address is preset for each system, DNN, or external operator information to support selection of a DNS address.

The H-UPF (e.g., 200) of the present disclosure may perform overall processing for session control/generation according to reception of the PFCP establishment request from the session control device (H-SMF) 100, and may select a DNS address related to the H-UPF (e.g., 200) with the local configuration and transmit a PFCP establishment response including the DNS address.

Accordingly, the controller 110 may obtain the DNS address selected by the H-UPF (e.g., 200) through the PFCP establishment request/response with the H-UPF (e.g., 200) selected for the UE (e.g., the domestic customer), and may include the DNS address in a response message (e.g., Nsmf_PDU_Create Response) sent to the V-SMF, thereby transmitting the DNS address selected by the H-UPF (e.g., 200) to the UE (e.g., the domestic customer).

Furthermore, the controller 110 may adjust the size of a maximum transmission unit (MTU) for the UE (e.g., the domestic customer) to be applied between the selected H-UPF (e.g., 200) and the V-UPF (see case #2 of FIG. 3) according to the H-UPF (e.g., 200).

As described above, the present disclosure may employ an internet service provider (ISP) for interworking between the H-UPF and the V-UPF, in which case, a connection therebetween may employ a VPN for security.

In the present disclosure, since using the VPN between the H-UPF and the V-UPF requires an additional security protocol header (e.g., IPsec), the size of the MTU may be adjusted by selecting/transmitting an MTU value (e.g., an IPv4 link MTU value) to the UE (e.g., the domestic customer) according to the H-UPF (e.g., 200) to prevent unnecessary fragmentation.

Accordingly, the controller 110 may adjust the size of the MTU for the UE (e.g., the domestic customer) by selecting/transmitting an MTU value (e.g., an IPv4 link MTU value) according to the presence and/or type of a security protocol header in a section between the currently selected H-UPF (e.g., 200) and the V-UPF (see case #2 of FIG. 3) to process traffic of the UE (e.g., the domestic customer).

Specifically, in the first embodiment, the controller 110 of the session control device (H-SMF) 100 has a local configuration in which a DNS address/IPv4 link MTU is preset for each UPF or UPF group, and may select a DNS address/IPv4 link MTU according to the currently selected H-UPF (e.g., 200) with the local configuration.

The controller 110 may include the selected DNS address/MTU value in a response message (e.g., Nsmf_PDU_Create Response) sent to the V-SMF after the PFCP establishment request/response with the selected H-UPF (e.g., 200) for the UE (e.g., the domestic customer), thereby transmitting the selected DNS address/MTU value to the UE (e.g., the domestic customer).

In the second embodiment, the controller 110 may obtain the DNS address/MTU value selected by the currently selected H-UPF (e.g., 200), and may transmit the DNS address/MTU value to the UE (e.g., the domestic customer).

Specifically describing the second embodiment, when a PDU session establishment request from the UE (e.g., the domestic customer) is received via the AMF (not shown)/V-SMF as described above, if a PCO (ePCO) IE exists in the received message (e.g., Nsmf_PDU_Create Request) and a DNS address request/IPv4 link MTU request exists in the PCO (ePCO), the controller 110 may include the DNS address request/IPv4 link MTU request in the PFCP establishment request to be transmitted to the H-UPF (e.g., 200).

The H-UPF (e.g., 200) of the present disclosure may have/manage a local configuration in which a DNS address/IPv4 link MTU is preset for each system, DNN, or external operator information.

The H-UPF (e.g., 200) of the present disclosure may perform overall processing for session control/generation according to reception of the PFCP establishment request from the session control device (H-SMF) 100, and may select a DNS address/IPv4 link MTU related to the H-UPF (e.g., 200) with the local configuration and transmit a PFCP establishment response including the DNS address/IPv4 link MTU.

Accordingly, the controller 110 may obtain the DNS address/MTU value selected by the H-UPF (e.g., 200) through the PFCP establishment request/response with the H-UPF (e.g., 200) selected for the UE (e.g., the domestic customer), and may include the DNS address/MTU value in a response message (e.g., Nsmf_PDU_Create Response) sent to the V-SMF, thereby transmitting DNS the selected address/MTU value to the UE (e.g., the domestic customer).

Table 1 is an IE structure proposed in the present disclosure to transmit a PFCP establishment request including a DNS address request/IPv4 link MTU request to the H-UPF.

TABLE 1
[TS 29.244] Table 7.5.2.1-1: Information Elements
in an PFCP Session Establishment Request

| Information | | | Appl. | | | | |
|---|---|---|---|---|---|---|---|
| elements | P | Condition/Comment | Sxa | Sxb | Sxc | N4 | IE Type |
| Node ID | M | This IE shall contain the unique | X | X | X | X | Node ID |
| | | identifier of the sending Node. | | | | | |
| CP F-SEID | M | This IE shall contain the unique | X | X | X | X | F-SEID |
| | | identifier allocated by the CP function | | | | | |
| | | identifying the session. | | | | | |
| . . . | . . . | . . . | | | | | |
| UEReq | M | This IE contains the UE requested | X | X | X | X | UEReq |
| | | protocol configuration Option | | | | | |

Table 2 is an IE structure proposed in the present disclosure to transmit a PFCP establishment response including a DNS address/IPv4 link MTU selected by the H-UPF according to the DNS address request/IPv4 link MTU request in the PFCP establishment request to the H-SMF.

TABLE 2
[TS 29.244] Table 7.5.3.1-1: Information Elements in an PFCP Session Establishment Response

| Information | | | Appl. | | | | |
|---|---|---|---|---|---|---|---|
| elements | P | Condition/Comment | Sxa | Sxb | Sxc | N4 | IE Type |
| Node ID | M | This IE shall contain the unique | X | X | X | X | Node ID |
| | | identifier of the sending Node. | | | | | |
| Cause | M | This IE shall indicate the acceptance | X | X | X | X | Cause |
| | | or the rejection of the corresponding | | | | | |
| | | request message. | | | | | |
| . . . | . . . | . . . | | | | | |
| UEResp | O | This IE contains the response for the | X | X | X | X | UEResp |
| | | UE requested protocol configuration Option | | | | | |

As described above with reference to the embodiments, according to the present disclosure, based on the basic deployment of the local H-UPF described above, the DNS address/MTU value (e.g., the IPv4 link MTU value) according to the local H-UPF of the UE (domestic customer) is transmitted to the UE (domestic customer), and thus the UE (domestic customer) may access the DNS and the application server located nearby to improve quality of experience (QOE), such as a response speed, and may configure an appropriate MTU size according to the presence/type of a security protocol header in a section between the V-UPF and the H-UPF to prevent unnecessary fragmentation in this network section, thereby improving performance.

Continuing with a specific description of the configuration of the session control device 100, the state management unit 120 is responsible for managing a network state for each other operator with respect to the UPF of the HPLMN, that is, the H-UPF (e.g., 200) selected to process the roaming traffic of the current UE (e.g., the domestic customer).

More specifically, the state management unit 120 may manage a network state per external operator information with respect to the H-UPF (e.g., 200) selected to process the roaming traffic of the current UE (e.g., the domestic customer).

As described above, the external operator information may be one or a combination of a plurality of pieces of the following information.
Serving PLMN information for UE
Required RTT (latency) and throughput for roaming UE
Required local/remote DNS information for roaming UE
Geographical location (physical and logical) for NFs

That is, the session control device (H-SMF) 100 of the present disclosure manages a network state per external operator information that generates a session for a roaming service with the H-UPF 200 with respect to each H-UPF that the session control device 100 manages, and may include the state management unit 120 for this purpose.

Specifically, when a PDU session establishment request from the UE (e.g., the domestic customer) is received via the AMF (not shown)/V-SMF as described above, the session control device (H-SMF) 100 of the present disclosure may select an H-UPF (e.g., 200) to process the roaming traffic of the UE (e.g., the domestic customer) by using the external operator information about the UE (e.g., the domestic customer) as a selection factor.

Therefore, the session control device (H-SMF) 100 may transmit a PFCP establishment request to the selected H-UPF (e.g., 200) for the UE (e.g., the domestic customer) according to an attach procedure, and may transmit a PFCP modification request as needed.

Here, the state management unit 120 may include the external operator information about the UE (e.g., the domestic customer) in the PFCP establishment request and/or PFCP modification request transmitted to the H-UPF (e.g., 200) for the UE (e.g., the domestic customer).

Accordingly, the H-UPF (e.g., 200) may manage the “external operator information” transmitted through the request received from the session control device (H-SMF) 100 as “mapping information” to be available later when reporting the state of the H-UPF (e.g., 200) or data traffic.

The PFCP establishment request and/or PFCP modification request transmitted from the SMF to the UPF is already provided with a downlink GTP-U TEID for the UE in the session.

Accordingly, the PFCP establishment request and/or PFCP modification request transmitted from the session control device (H-SMF) 100 of the present disclosure to the H-UPF (e.g., 200) is provided with the downlink GTP-U TEID (e.g., V-UPF GTPU IP) for the UE (e.g., the domestic customer) in the session.

In addition, the state management unit 120 of the session control device (H-SMF) 100 of the present disclosure transmits the PFCP establishment request and/or PFCP modification request transmitted to the H-UPF (e.g., 200) by further including the external operator information (e.g., a serving network PLMN IE) about the UE (e.g., the domestic customer).

Accordingly, the H-UPF (e.g., 200) of the present disclosure may manage, for example, generate/retain/update, “mapping information” in which the external operator information (e.g., the serving network PLMN IE) and the downlink GTP-U TEID (e.g., the V-UPF GTPU IP) transmitted through the request received from the session control device (H-SMF) 100 are mapped, and may use the mapping information later when reporting the state of the H-UPF (e.g., 200) or data traffic.

Hereinafter, the configuration of the data processing device 200 according to an embodiment of the present disclosure will be described in detail with reference to FIG. 4.

The data processing device 200 of the present disclosure may be a CU-CP, a UPF, or an SGW-U/PGW-U, and may be a device belonging to an operator's home PLMN from the perspective of a roaming service for a customer (e.g., a domestic customer) accessing other PLMNS (e.g., overseas).

However, for convenience of explanation, the data processing device 200 will be described below as the UPF (hereinafter, an H-UPF), which is one of the CU-CP, the UPF, and the SGW-U/PGW-U.

As illustrated in FIG. 4, the data processing device 200 of the present disclosure includes an information identification unit 210 and a controller 220.

The entirety or at least a portion of the foregoing configuration of the data processing device 200 may be configured as a hardware module, a software module, or a combination of hardware and software modules.

Here, the software module may be understood as, for example, an instruction executed by a processor that controls an operation within the data processing device 200, and the instruction may be stored in a memory within the data processing device 200.

Ultimately, the data processing device 200 of the present disclosure implements the method for the service (e.g., the roaming service) between the different PLMNs proposed in the present disclosure through the foregoing configuration. Hereinafter, each component in the data processing device 200 for implementing the method will be described in more detail.

The information identification unit 210 is responsible for identifying external operator information also transmitted when receiving a request for a UE utilizing a service between the HPLMN and a VPLMN.

That is, when receiving a PFCP establishment request and/or a PFCP modification request for the UE (e.g., a domestic customer) from the session control device (H-SMF) 100 of the present disclosure as described above, the information identification unit 210 may identify whether there is “external operator information (e.g., a serving network PLMN IE)” transmitted together with a downlink GTP-U TEID (e.g., a V-UPF GTPU IP) through the received request.

When the information identification unit 210 identifies the “external operator information,” the controller 220 may manage, for example, generate/retain/update, “mapping information” in which the identified external operator information and the downlink GTP-U TEID (e.g., the V-UPF GTPU IP) are mapped.

Table 3 and Table 4 illustrate IE structures proposed in the present disclosure to transmit a PFCP establishment/modification request including external operator information to the H-UPF.

TABLE 3
[TS 29.244] Table 7.5.2.1-1: Information Elements in an PFCP Session Establishment Request

| Information | | | Appl. | | | | |
|---|---|---|---|---|---|---|---|
| elements | P | Condition/Comment | Sxa | Sxb | Sxc | N4 | IE Type |
| Node ID | M | This IE shall contain the unique | X | X | X | X | Node ID |
| | | identifier of the sending Node. | | | | | |
| CP F-SEID | M | This IE shall contain the unique identifier | X | X | X | X | F-SEID |
| | | allocated by the CP function identifying | | | | | |
| | | the session. | | | | | |
| . . . | . . . | . . . | | | | | |
| External | O | This IE shall contain the External Operator | | X | | X | External |
| Operator | | Information which is received by AMF | | | | | Operator |
| Information | | | | | | | Information |

TABLE 4
[TS 29.244] Table 7.5.4.1-1: Information Elements in an PFCP Session Modification Request

| Information | | | Appl. | | | | |
|---|---|---|---|---|---|---|---|
| elements | P | Condition/Comment | Sxa | Sxb | Sxc | N4 | IE Type |
| CP F-SEID | M | This IE shall be present if the CP function | X | X | X | X | F-SEID |
| | | decides to change its F-SEID for the PFCP | | | | | |
| | | session. The UP function shall use the new | | | | | |
| | | CP F-SEID for subsequent PFCP Session | | | | | |
| | | related messages for this PFCP Session. | | | | | |
| | | See Note 2. | | | | | |
| . . . | . . . | . . . | | | | | |
| External | O | This IE shall contain the External Operator | | X | | X | External |
| Operator | | Information which is received by AMF | | | | | Operator |
| Information | | | | | | | Information |

As described above, in the present disclosure, external operator information (e.g., a serving network PLMN IE) may be transmitted between the session control device (H-SMF) 100 and the data processing device (H-UPF) 200, and thus the data processing device (H-UPF) 200 may manage “mapping information” in which the external operator information and a downlink GTP-U TEID (e.g., a V-UPF GTPU IP) are mapped, thereby enabling the data processing device (H-UPF) 200 to report the state of data traffic between the data processing device 200 and the V-UPF.

Specifically, the controller 220 may monitor the state (e.g., out-of-service, RTT, throughput QoS, error rate, or packet fragmentation) of data traffic between each V-UPF and the H-UPF for each V-UPF that provides a roaming service by interworking with the H-UPF 200.

For example, the controller 220 may monitor a connection state in a section with each V-UPF through a GTP-U echo request/response, and this function is an operation already provided in a 3GPP standard.

Therefore, when detecting a failure by watch/monitoring through the GTP-U echo request/response, the controller 220 may report the detected failure to the session control device (H-SMF) 100 through a node report request (user plane path failure report).

Further, when detecting failure recovery by watch/monitoring through a GTP-U echo request/response, the controller 220 may report the failure recovery to the session control device (H-SMF) 100 through a node report request (user plane path recovery report).

Here, the controller 220 may use the “mapping information” when reporting the state of data traffic (e.g., failure/recovery state) of the H-UPF 200 or the V-UPF to H-UPF section as described above, thereby enabling the session control device (H-SMF) 100 to identify the V-UPF to H-UPF section based on the report and manage a network state per external operator information for each H-UPF.

Specifically, when reporting failure detection and/or a failure recovery (node report request) to the session control device (H-SMF) 100 as described above, the controller 220 identifies and transmits related external operator information and GTP-U information from the “mapping information” currently managed.

That is, in the present disclosure, the report (node report request) needs to include external operator information.

Table 5 to Table 7 illustrate IE structures proposed in the present disclosure to transmit a node report request including external operator information and GTP-U information (remote GTP-U peer) to the H-SMF.

TABLE 5
[TS 29.244] Table 7.4.5.1.1-1: Information Elements in PFCP Node Report Request

| Information | | | Appl. | | | | | |
|---|---|---|---|---|---|---|---|---|
| elements | P | Condition/Comment | Sxa | Sxb | Sxc | N4 | N4mb | IE Type |
| User Plane | C | This IE shall be present if the Node | X | X | — | X | X | User Plane |
| Path Failure | | Report Type indicates a User Plane | | | | | | Path Failure |
| Report | | Path Failure Report. | | | | | | Report |
| User Plane | C | This IE shall be present if the Node | X | X | — | X | X | User Plane |
| Path Recovery | | Report Type indicates a User Plane | | | | | | Path Recovery |
| Report | | Path Recovery Report. | | | | | | Report |

TABLE 6
[TS 29.244] User Plane Path Failure Report IE within PFCP Node Report Request

| | Octet 1 and 2 | | | | | | | |
|---|---|---|---|---|---|---|---|---|
| | User Plane Path Failure Report IE Type = 102 | | | | | | | |
| | (decimal) | | | | | | | |
| | Octets 3 and 4 | | | | | | | |
| | Length = n | | | | | | | |
| Information | | | Appl. | | | | | |
| elements | P | Condition/Comment | Sxa | Sxb | Sxc | N4 | N4mb | IE Type |
| Remote GTP- | M | This IE shall | X | X | — | X | X | Remote GTP- |
| U Peer | | contain the IP | | | | | | U Peer |
| | | address of the | | | | | | |
| | | remote GTP-U peer | | | | | | |
| | | towards which a | | | | | | |
| | | user plane path | | | | | | |
| | | failure has been | | | | | | |
| | | detected. (The | | | | | | |
| | | rest is omitted.) | | | | | | |
| External | C | This IE shall | | X | | X | | External |
| Operator | | transmit a | | | | | | Operator |
| Information | | serving PLMN | | | | | | Information |
| | | value | | | | | | |
| | | corresponding to | | | | | | |
| | | the remote GTP-U | | | | | | |
| | | peer . Multiple | | | | | | |
| | | external operator | | | | | | |
| | | information IEs | | | | | | |
| | | may exist, and | | | | | | |
| | | the number of | | | | | | |
| | | external operator | | | | | | |
| | | information IEs | | | | | | |
| | | shall be the same | | | | | | |
| | | as the number of | | | | | | |
| | | remote GTP-U | | | | | | |
| | | peers. When | | | | | | |
| | | there is no | | | | | | |
| | | external operator | | | | | | |
| | | information | | | | | | |
| | | corresponding to | | | | | | |
| | | the remote GTP-U | | | | | | |
| | | peers, | | | | | | |
| | | external | | | | | | |
| | | operator | | | | | | |
| | | information shall | | | | | | |
| | | be transmitted as | | | | | | |
| | | MCC = 000 and | | | | | | |
| | | MNC = 000. | | | | | | |

TABLE 7
[TS 29.244] User Plane Path Recovery Report IE within PFCP Node Report Request

| | Octet 1 and 2 | | | | | | | |
|---|---|---|---|---|---|---|---|---|
| | User Plane Path Recovery Report IE Type = 187 | | | | | | | |
| | (decimal) | | | | | | | |
| | Octets 3 and 4 | | | | | | | |
| | Length = n | | | | | | | |
| Information | | | Appl. | | | | | |
| elements | P | Condition/Comment | Sxa | Sxb | Sxc | N4 | N4mb | IE Type |
| Remote GTP- | M | This IE shall | X | X | — | X | X | Remote GTP- |
| U Peer | | contain the IP | | | | | | U Peer |
| | | address of the | | | | | | |
| | | remote GTP-U peer | | | | | | |
| | | towards which | | | | | | |
| | | user plane path | | | | | | |
| | | failure was | | | | | | |
| | | reported . . . (The | | | | | | |
| | | rest is omitted.) | | | | | | |
| External | C | This IE shall | | X | | X | | External |
| Operator | | transmit external | | | | | | Operator |
| Information | | operator | | | | | | Information |
| | | information | | | | | | |
| | | corresponding to | | | | | | |
| | | the remote GTP-U | | | | | | |
| | | peer. Multiple | | | | | | |
| | | external operator | | | | | | |
| | | information IEs | | | | | | |
| | | may exist, and | | | | | | |
| | | the number of | | | | | | |
| | | external operator | | | | | | |
| | | information IEs | | | | | | |
| | | shall be the same | | | | | | |
| | | as the number of | | | | | | |
| | | remote GTP-U | | | | | | |
| | | peers. When | | | | | | |
| | | there is no | | | | | | |
| | | external operator | | | | | | |
| | | information | | | | | | |
| | | corresponding to | | | | | | |
| | | the remote GTP-U | | | | | | |
| | | peers, | | | | | | |
| | | external | | | | | | |
| | | operator | | | | | | |
| | | information shall | | | | | | |
| | | be transmitted as | | | | | | |
| | | MCC = 000 and | | | | | | |
| | | MNC = 000. | | | | | | |

Accordingly, in the present disclosure, the session control device (H-SMF) 100 may manage a network state per external operator information for the corresponding H-UPF 200 by using at least one of the external operator information and the GTP-U information (remote GTP-U Peer) according to the report (node report request) from the H-UPF 200.

Further, in the present disclosure, the session control device (H-SMF) 100, particularly the state management unit 120, may manage a network state by other operators, that is, a network state per external operator information, for the UPF of the HPLMN, including latency and throughput information in a UE-UPF-Internet section and latency and throughput information between the session control device (H-SMF) 100 and the UPF of the HPLMN in a different region.

The controller 220 of the data processing device (H-UPF) 200 may retain/manage a local configuration in which a DNS address/IPv4 link MTU is preset for each system, DNN, or external operator information.

Accordingly, when receiving a PFCP establishment request from the session control device (H-SMF) 100, the controller 220 may perform overall processing for session control/generation according to reception of the PFCP establishment request, and may select a DNS address/IPv4 link MTU related to the H-UPF (e.g., 200) with the local configuration and transmit a PFCP establishment response including the DNS address/IPv4 link MTU.

The configuration in which the state management unit 120 of the session control device 100 manages the network state per external operator information for each H-UPF will be described again.

As with the foregoing embodiment, the following description is made by referring to the H-UPF (e.g., 200) selected using the external operator information (e.g., the serving PLMN) about the UE (e.g., the domestic customer).

The state management unit 120 manages the network state per external operator information for the H-UPF (e.g., 200), based on the state of data traffic (e.g., failure/recovery) in a section between the UPF of the VPLMN and the UPF of the HPLMN reported using the “mapping information,” that is, the information in which the external operator information and the downlink GTP-U TEID from the H-UPF (e.g., 200) are mapped.

Specifically, when failure detection (e.g., a node report request (user plane path failure report)) including external operator information and GTP-U information is reported from a UPF of a specific HPLMN, for example, the H-UPF 200, the state management unit 120 may manage the external operator information according to the report of the failure detection as out of service for the H-UPF 200.

In addition, when the controller 110 selects an H-UPF by using the external operator information of out-of-service, the state management unit 120 excludes the H-UPF 200 from selection by interworking with the controller 110.

When the failure detection (e.g., the node report request (user plane path failure report)) is reported from the H-UPF 200, the controller 110 may delete a PDU session of the UE (e.g., the domestic customer) using the roaming service by using the GTP-U information (remote GTP-U peer) according to the report, and may select a UPF of a backup HPLMN designated previously when reattaching a PDU session of the UE (e.g., the domestic customer).

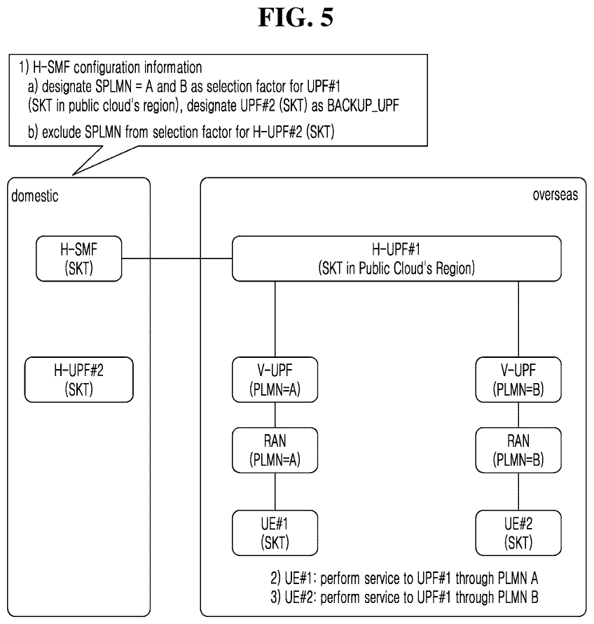

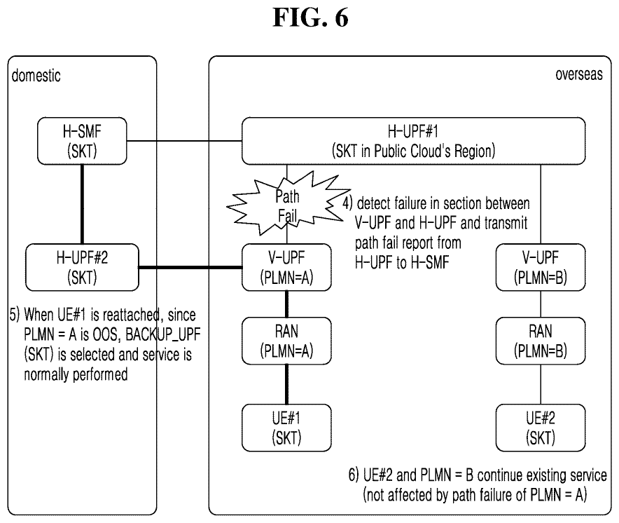

FIG. 5 and FIG. 6 illustrate a scenario of diverting a call to a backup H-UPF when a failure occurs in a section between a V-UPF and an H-UPF according to the present disclosure.

First, referring to FIG. 5, 1) the H-SMF may configure H-SMF configuration information by designating a (H-) UPF by external operator information using the external operator information (e.g., a serving PLMN) as a selection factor and designating a backup (H-) UPF.

In FIG. 5, “H-SMF configuration information” is illustrated as an example in which external operator information (serving PLMN)=A and B is designated as a selection factor for H-UPF #1, H-UPF #2 is designated as a backup UPF, and external operator information is not specified and is excluded as a selection factor for H-UPF #2, which serves as the backup UPF.

Accordingly, the H-SMF selects H-UPF #1 for domestic customer UE #1 connected to external operator information (serving PLMN=A), and also selects H-UPF #1 for domestic customer UE #2 connected to external operator information (serving PLMN=B), thus enabling 2) UE #1 to perform a service (e.g., a roaming service) to H-UPF #1 via PLMN A and 3) UE #2 to perform a service (e.g., a roaming service) to H-UPF #1 via PLMN B.

Here, as illustrated in FIG. 6, 4) when a failure occurs in a section between the V-UPF of PLMN A and H-UPF #1, H-UPF #1 may detect the failure and report failure detection by transmitting a path failure report including the external operator information (serving PLMN=A) and GTP-U information to the H-SMF using “mapping information.”

In this case, the H-SMF may manage PLMN A as being out of service in a network state per external operator information for H-UPF #1 according to the report of the failure detection, may delete a PDU session of UE #1 using the GTP-U information (remote GTP-U peer) according to the report of the failure detection, and may immediately block a new signaling message for H-UPF #1 from the UE connected to PLMN A to exclude H-UPF #1 from selection while managing PLMN A as being out of service for H-UPF #1.

5) When a PDU session of UE #1 is reattached, the H-SMF selects backup H-UPF #2 since PLMN A is in an out-of-service state for H-UPF #1 for which PLMN A is designated as the selection factor, thus enabling UE #1 to continue to perform the service (e.g., the roaming service) normally by diverting a call to H-UPF #2 through PLMN A.

In this process, even though a failure occurs in one VPLMN (e.g., PLMN A) for the same H-UPF #1, a service on another VPLMN (e.g., PLMN B) needs not to be affected. In the present disclosure, 6) UE #2 and PLMN B may continue to use the service (e.g., the roaming service) in use without being affected by a path failure of PLMN A.

As described with reference to the above example, according to the present disclosure, the H-UPF reports failure detection/recovery in a section between the H-UPF and the V-UPF, and the H-SMF manages a network state per external operator information for each H-UPF, based on the failure detection/recovery, and performs isolation of a failed VPLMN and diversion of a call to a backup H-UPF without affecting other VPLMNs' services.

As described above, the session control device and the data processing device of the present disclosure are based on deployment of an H-UPF in a region of another PLMN (e.g., an overseas region), thus realizing a specific technical configuration of enabling local breakout so that a domestic subscriber UE accesses an application server located nearby (e.g., in an overseas region).

Accordingly, the present disclosure realizes a novel technical method that enables a domestic subscriber UE located overseas to access an application server located nearby (e.g., in an overseas region) by local breakout, thereby improving quality of experience (QoE) of a customer and reducing international circuit traffic.

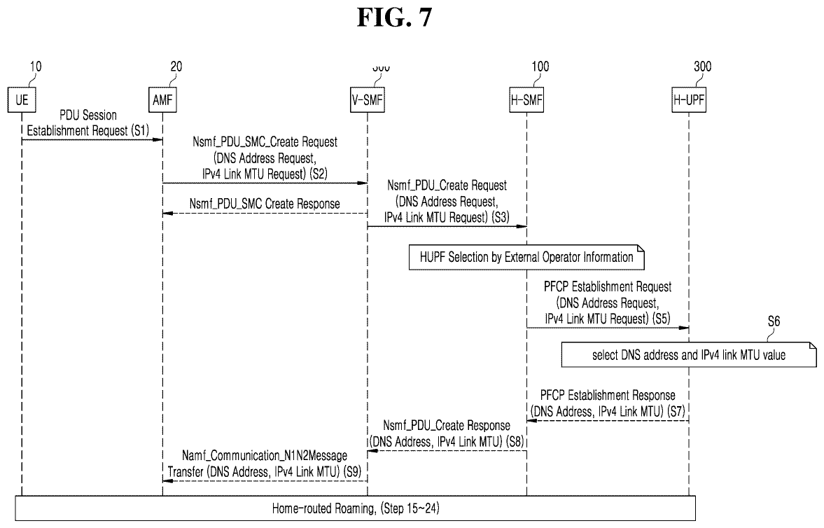

Hereinafter, embodiments of performing the method for the service between the different PLMNs realized by the present disclosure are described with reference to FIG. 7 to FIG. 9. For convenience of explanation, a description is made with reference to the aforementioned H-SMF 100 and H-UPF 200.

First, FIG. 7 illustrates a call flow for selecting a DNS and an MTU by the method for the service between the different PLMNs according to an embodiment of the present disclosure.

According to the present disclosure, a method for selecting a DNS and an MTU includes method 1 in which an SMF selects a DNS and an MTU by using a local configuration and method 2) in which an SMF requests a UPF to select a DNS and an MTU and receives a selection from the UPF. Method 1 corresponds to a first embodiment described above, and method 2 corresponds to a second embodiment described above.

FIG. 7 illustrates method 2 as an embodiment.

When a UE of a domestic customer, that is, a UE 10, attempts to use a roaming service overseas, a PDU session establishment request from the UE 10 connected via an overseas VPLMN is received as an Nsmf_PDU_Create request by the H-SMF 100 of the present disclosure via an AMF 20/V-SMF 300 (S1, S2, and S3).

According to an embodiment of the present disclosure, when receiving the Nsmf_PDU_Create request, the H-SMF 100 selects the H-UPF 200 by using external operator information about the UE 10 (S4).

According to an embodiment (e.g., method 2) of the present disclosure, when there is a PCO (ePCO) IE in the received Nsmf_PDU_Create request and DNS address request/IPv4 link MTU request in the PCO (ePCO), the H-SMF 100 may include the DNS address request/IPv4 link MTU request in a PFCP establishment request to be transmitted to the H-UPF 200 (S5).

The H-UPF 200 of the present disclosure may retain/manage a local configuration in which a DNS address/IPv4 link MTU is preset for each system, DNN, and external operator information to support selection of a DNS address selection/MTU value.

According to an embodiment of the present disclosure (e.g., method 2), the H-UPF 200 may perform overall processing for session control/generation according to reception of the PFCP establishment request from the H-SMF 100, and may select a DNS address/IPv4 link MTU related to the H-UPF 200 with the retained local configuration and transmit a PFCP establishment response including the DNS address/IPv4 link MTU (S6 and S7).

According to an embodiment of the present disclosure (e.g., method 2), the H-SMF 100 may obtain a DNS address/MTU value through the PFCP establishment request/response with the H-UPF 200 selected for the UE 10, and may include the DNS address/MTU value in a Nsmf_PDU_Create response to be sent to the V-SMF 300, thereby transmitting the selected DNS address/MTU value to the UE 10 (S8 and S9).

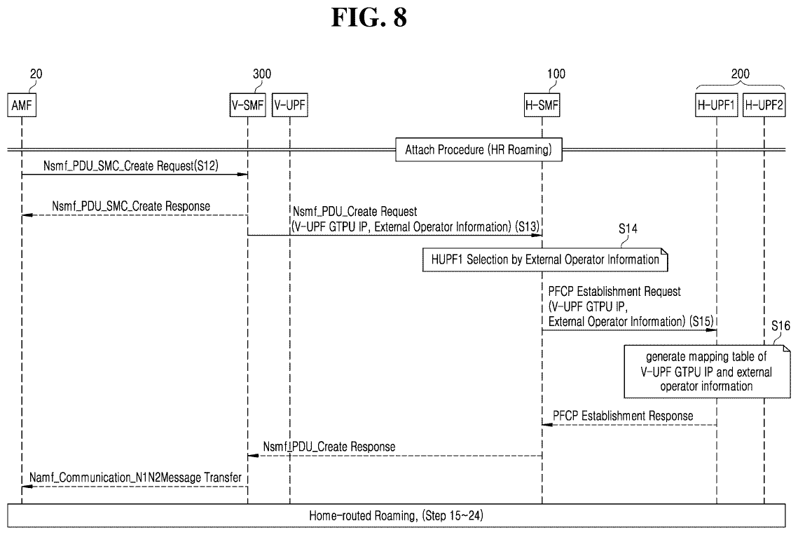

FIG. 8 illustrates a call flow for managing mapping information used by a UPF when reporting failure detection and/or failure recovery by the method for the service between different PLMNs according to an embodiment of the present disclosure.

When a UE of a domestic customer, that is, a UE 10, attempts to use a roaming service overseas, a PDU session establishment request from the UE connected via an overseas VPLMN is received as an Nsmf_PDU_Create request by the H-SMF 100 of the present disclosure via an AMF 20/V-SMF 300 (S12 and S13).

According to an embodiment of the present disclosure, when receiving the Nsmf_PDU_Create request, the H-SMF 100 selects the H-UPF 200 by using external operator information (e.g., a serving PLMN, etc.) about the UE (S14).

According to an embodiment of the present disclosure, the H-SMF 100 transmits a PFCP establishment request to the H-UPF 200 selected for the UE according to an attach procedure, may transmit the PFCP and establishment request by further including not only a downlink GTP-U TEID (e.g., a V-UPF IP) a GTPU of corresponding session but also the external operator information (e.g., the serving network PLMN IE) about the UE (S15).

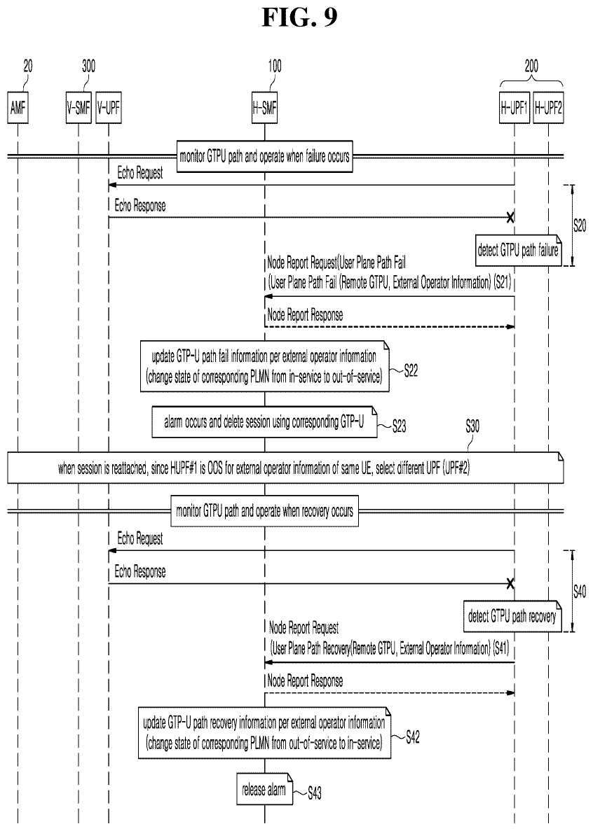

Accordingly, according to an embodiment of the present disclosure, the H-UPF 200 may manage, for example, generate/retain/update, “mapping information” in which the external operator information (e.g., the serving network PLMN IE) and the downlink GTP-U TEID (e.g., the V-UPF GTPU IP) transmitted through the request received from the H-SMF 100 are mapped (S16), and may use the mapping information later when reporting the state (e.g., failure/recovery) of data traffic of a section between the H-UPF 200 and each V-UPF (described in FIG. 9).

FIG. 9 illustrates a call flow for processing when detecting a failure in a section between a UPF of a VPLMN and a UPF of an HPLMN and recovering from the failure by the method for the service between the different PLMNs according to an embodiment of the present disclosure.

According to an embodiment of the present disclosure, the H-UPF (H-UPF1/H-UPF2) 200 may monitor whether a failure occurs in a section between each V-UPF and the H-UPF for each V-UPF that provides a roaming service interworking with the H-UPF 200 (S20 and S40). The following description is made with reference to H-UPF1.

For example, H-UPF1 may watch/monitor a connection state in the section with each V-UPF through a GTP-U echo request/response, and this function is an operation already provided in a 3GPP standard.

According to an embodiment of the present disclosure, when detecting occurrence of a failure (GTPU path fail) by watch/monitoring through the GTP-U echo request/response (S20), H-UPF1 may report the detected failure to the H-SMF 100 via a node report request (user plane path failure report) (S21).

When reporting the detected failure to the H-SMF 100 via the node report request (user plane path failure report), H-UPF1 identifies and transmits related external operator information (e.g., a serving network PLMN IE) and GTP-U information (remote GTP-U) from “mapping information” (S21).

According to an embodiment of the present disclosure, when receiving the node report request including the external operator information and the GTP-U information (remote GTP-U) from H-UPF1, the H-SMF 100 may update the state of the PLMN in which the current detected failure is reported by changing the state of the PLMN from in-service to out-of-service in a network state per external operator information (e.g., serving PLMN) for H-UPF1 (S22), and may delete a PDU session for the UE that uses a GTP-U IP for which the current detected failure is reported (S23).

In addition, according to an embodiment of the present disclosure, when reattaching a PDU session of the UE, since previous H-UPF1 is out-of-service for the same external operator information (e.g., the serving PLMN) of the same UE, the H-SMF 100 selects H-UPF2 as a backup H-UPF, thus enabling the UE to continue to normally perform a service (e.g., a roaming service) by diverting a call to H-UPF2 through the same external operator information (e.g., the serving PLMN) (S30).

According to embodiment of the present an disclosure, when detecting a failure recovery (GTPU path recovery) by watch/monitoring through a GTP-U echo request/response (S40), the H-UPF1 may report the failure recovery to the H-SMF 100 through a node report request (user plane path recovery report) (S41).

When reporting the failure recovery to the H-SMF 100 through the node report request (user plane path recovery report), the H-UPF1 identifies and transmits related external operator information (e.g., a serving network PLMN IE) and GTP-U information (remote GTP-U) from the “mapping information” (S41).

According to an embodiment of the present disclosure, when receiving the node report request including the external operator information (e.g., the serving network PLMN IE) and the GTP-U information (remote GTP-U) from the H-UPF1, the H-SMF 100 may update the state of the PLMN for which the failure recovery is reported by changing the state of the PLMN from out-of-service to in-service in the network state per each external operator information (e.g., the serving PLMN) for H-UPF1 (S42), and may release an action related to the out-of-service state, such as releasing an alarm (S43).

As described above, according to the method for the service between the different PLMNs of the present disclosure, based on deployment of an H-UPF in a region of another PLMN (e.g., an overseas region), a specific technical configuration of enabling local breakout is realized so that a domestic subscriber UE accesses an application server located nearby (e.g., in an overseas region).

Accordingly, the present disclosure realizes a novel technical method that enables a domestic subscriber UE located overseas to access an application server located nearby (e.g., in an overseas region) by local breakout, thereby improving quality of experience of a customer and reducing international circuit traffic.

The method for the service between the different PLMNs according to the embodiment of the present disclosure may be configured in the form of program instructions that can be executed through various computer devices and may be recorded in a computer-readable medium. The computer-readable medium may include a program instruction, a data file, a data structure, and the like alone or in combination. The program instruction recorded in the medium may be specially designed and configured for the present disclosure, or may be known and available to those skilled in computer software. Examples of the computer-readable recording medium include magnetic media, such as a hard disk, a floppy disk, and a magnetic tape, optical media, such as a CD-ROM and a DVD, magneto-optical media, such as a floptical disk, and a hardware device specially configured to store and perform a program instruction, such as a ROM, a RAM, and a flash memory. Examples of the program instruction include not only a machine code made by a compiler but also a high-level language code executable by a computer using an interpreter. The hardware device may be configured to operate as one or more software modules to perform an operation of the present disclosure, and vice versa.

Although the present disclosure has been described in detail with reference to various embodiments, the present disclosure is not limited to these embodiments, and various changes and modifications may be made by those skilled in the art to which the present disclosure belongs without departing from the gist of the present disclosure claimed in the following claims.

1. A session control device comprising:
a controller configured to enable traffic according to a service between a home public land mobile network (hereinafter, an HPLMN) and a visited PLMN (hereinafter, a VPLMN) to be processed in a user plane function (UPF) of an HPLMN deployed in a region where a UE using the service is located, based on whether the UE is a UE of a different operator UE; and
a state management unit configured to manage a network state per different operator for the UPF of the HPLMN.

2. The session control device of claim 1,
wherein whether the UE is the UE of the different operator is identified according to at least one of the VPLMN, requested single-network slice selection assistance information (S-NSSAI), an international mobile equipment identity (IMEI), and an international mobile subscriber identity (IMSI) of the UE.

3. The session control device of claim 1,
wherein the controller is configured to select a UPF of an HPLMN to process the traffic by using external operator information about the UE, and to transmit the external operator information, and
wherein the state management unit is configured, for the selected UPF of the HPLMN, to manage a network state for each external operator information based on a state of data traffic in a section between a UPF of a VPLMN and the selected UPF of the HPLMN, the state being reported by the selected UPF using mapping information in which the external operator information and a downlink GTP-U TEID are mapped.

4. The session control device of claim 3,
wherein the state management unit is configured to transmit the external operator information when transmitting a session establishment request and/or a session modification request for the UE to the selected UPF of the HPLMN to enable the UPF of the HPLMN to retain the information in which the transmitted external operator information and the downlink GTP-U TEID for the UE are mapped and to use the information when reporting a state of the UPF or data traffic.

5. The session control device of claim 3,
wherein the state management unit is configured to:
manage a network state of external operator information according to a report for a UPF of a specific HPLMN when a state of the UPF or data traffic comprising the external operator information and GTP-U information is reported from the UPF of the specific HPLMN; and
exclude the UPF of the specific HPLMN from selection according to the network state of the external operator information about the specific HPLMN when the controller selects the UPF of the HPLMN by using the external operator information.

6. The session control device of claim 1, wherein the controller is configured to:
select a UPF of an HPLMN to process the traffic by using external operator information about the UE; and
enable the UE to access a service server located close to the UE through a domain name server (DNS) close to the selected UPF of the HPLMN.

7. The session control device of claim 6,
wherein the controller is configured to:
select a DNS address according to the UPF of the HPLMN with a local configuration in which a DNS address is preset for each UPF or UPF group to transmit the DNS address to the UE; or
obtain a DNS address selected by the selected UPF of the HPLMN to transmit the DNS address to the UE.

8. The session control device of claim 6,
wherein the controller is configured to adjust a maximum transmission unit (MTU) size for the UE according to presence and/or type of a security protocol header in a section between the UPF of the VPLMN and the UPF of the HPLMN to process the traffic.

9. The session control device of claim 8,
wherein the controller is configured to:
select an MTU value according to the UPF of the HPLMN with a local configuration in which an IPv4 link MTU is preset for each UPF or UPF group to transmit the MTU value to the UE; or
obtain an MTU value selected by the selected UPF of the HPLMN to transmit the MTU value to the UE.

10. The session control device of claim 1,
wherein the state management unit is configured to manage latency and throughput information about a UE-UPF-Internet section and latency and throughput information between the session control device and a UPF of an HPLMN in a different region inclusively when managing the network state per different operator for the UPF of the HPLMN.

11. The session control device of claim 5,
wherein the controller is configured to:
delete a PDU session of the UE using the service by using GTP-U information according to the report when detection of a failure is reported as the state of the UPF or the data traffic; and
select a UPF of a predetermined backup HPLMN when the PDU session of the UE is reattached.

12. The session control device of claim 6,
wherein the controller is configured to transmit a request to be transmitted to the selected UPF of the HPLMN for the UE by including at least one of a DNS address request and an MTU request when there is at least one of the DNS address request and the MTU request in a session-related message from the UE.

13. A data processing device comprising:
an information identification unit configured to identify external operator information also transmitted when receiving a request for a UE using a service between a home public land mobile network (hereinafter, an HPLMN) and a visited PLMN (hereinafter, a VPLMN); and
a controller configured to manage information in which the identified external operator information and a downlink GTP-U TEID for the UE are mapped and to use the information when reporting a state of data traffic in a section between a UPF of a VPLMN and a UPF of an HPLMN to process traffic according to the service.

14. The data processing device of claim 13,
wherein the controller is configured to identify and transmit related external operator information and GTP-U information from the mapping information when reporting the state of the data traffic to an SMF of the HPLMN to enable the SMF of the HPLMN to manage a network state per external operator information for the UPF of the HPLMN by using at least one of the external operator information and GTP-U information according to the report.

15. The data processing device of claim 13,
wherein, when at least one of a DNS address request and an MTU request is transmitted when receiving the request for the UE, the controller is configured to select a DNS address and an MTU related to the data processing device with a local configuration in which at least one of a DNS address and an MTU is preset for each system, each DNN, or each external operator information and to transmit the DNS address and the MTU via a response to the request for the UE.

16. A method for a service between different PLMNs performed by a session control device, the method comprising:
a control operation of enabling traffic according to a service between a home public land mobile network (hereinafter, an HPLMN) and a visited PLMN (hereinafter, a VPLMN) to be processed in a user plane function (UPF) of an HPLMN deployed in a region where a UE using the service is located, based on whether the UE is a UE of a different operator UE; and
a state management operation of managing a network state per different operator for the UPF of the HPLMN.

17. A method for a service between different PLMNs performed by a data processing device, the method comprising:
an information identification operation of identifying external operator information also transmitted when receiving a request for a UE using a service between a home public land mobile network (hereinafter, an HPLMN) and a visited PLMN (hereinafter, a VPLMN); and
a control operation of managing information in which the identified external operator information and a downlink GTP-U TEID for the UE are mapped and using the information when reporting a state of data traffic in a section between a UPF of a VPLMN and a UPF of an HPLMN to process traffic according to the service.
